(19) United States
(12) Patent Application Publication
(10) Pub. No.: US 2009/0288990 A1
(43) Pub. Date: Nov. 26, 2009

(54) Catalyst for Catalytic Cracking Fluidized Bed

(75) Inventors: Zaiku Xie, Shanghai (CN); Guangwei Ma, Shanghai (CN); Weimin Yang, Shanghai (CN); Hui Yao, Shanghai (CN); Jingxian Xiao, Shanghai (CN); Liang Chen, Shanghai (CN)

Correspondence Address: MARSHALL, GERSTEIN & BORUN LLP, 233 SOUTH WACKER DRIVE, 6300 SEARS TOWER, CHICAGO, IL, 60606-6357, US

(73) Assignees: China Petroleum & Chemical Corporation, Beijing (CN); Shanghai Research Institute of Petrochemical Technology Sinopec, Shanghai (CN)

(21) Appl. No.: 12/063,598

(22) PCT Filed: Aug. 15, 2006
(86) PCT No.: PCT/CN06/02072

§ 371 Date: Sep. 9, 2008

(30) Foreign Application Priority Data
Aug. 15, 2005 (CN) 200510028794.3

(51) Int. Cl. B01J 21/12; C10G 11/05

(52) U.S. Cl. 208/120.05; 502/73; 208/120.35; 208/120.15; 208/120.25; 208/120.3

(57) ABSTRACT

The present invention relates to a catalyst for catalytic cracking fluidized-bed, and the technical problems to be primarily solved by the present invention are high reaction temperature, low cryogenic activity of catalysts and worse selectivity during the preparation of ethylene-propylene by catalytically cracking naphtha. The present invention uses the composition having the chemical formula (on the basis of the atom ratio): AₐB_{b}P_{c}Oₓ, so as to magnificently solve said problems. The present invention therefore can be industrially used to produce ethylene and propylene by catalytically cracking naphtha.

### TECHNICAL FIELD

The present invention relates to a catalyst for catalytic cracking fluidized-bed, especially a catalyst for fluidized-bed to produce ethylene-propylene by catalytically cracking naphtha.

### BACKGROUND ART

Currently, the primary process for producing ethylene-propylene is the steam pyrolysis, and the commonly used materials are naphtha. However, there are several shortcomings for steam pyrolysis of naphtha, e.g. high reaction temperature, rigorous technological conditions, high requirements on the devices, particularly on the furnace tube materials, and high-loss. Various meaningful studies thus are carried out. Catalytic cracking is the most attracting and promising one, and the object thereof is to find a suitable cracking catalyst to increase the selectivity of ethyelene-propylene, decrease the reaction temperature and have some certain flexibility of the ethylene-propylene yield.

From the current documents, most catalytic cracking researchers generally use the molecular sieves having a high silica alumina ratio as the catalytic materials and use high valent metallic ions for exchanging and impregnating. However, the molecular sieves have a worse hydrothermal stability and are difficult to regenerate.

U.S. Pat. No. 6,211,104 and CN1504540A disclosed a catalyst comprising 10˜70 wt % of clay, 5˜85 wt % of inorganic oxides and 1-50 wt % of molecular sieves. Various materials for the conventional steam pyrolysis therein exhibited excellent activity stability and high yields of light olefin, especially ethylene, wherein said molecular sieves were produced by impregnating 0˜25 wt % of Y type zeolite having a high silica alumina ratio or ZSM molecular sieves having MFI structure with phosphorus/alumina, magnesium or calcium, and were substantially the pure molecular sift catalysts.

In addition, oxides are also used as catalysts.

U.S. Pat. No. 4,620,051 and U.S. Pat. No. 4,705,769 of PHILLIPS PETROLEUM CO (US) disclosed using the oxide catalyst having manganese oxide and iron oxide as active ingredients and added with rare earth element La and alkaline earth metal Mg to crack C₃ and C₄ materials. Under the circumstance that Mn,Mg/Al₂O₃ catalyst was placed in the fixed-bed reactor in the laboratory, water and butane are in a molar ratio of 1:1 at a temperature of 700° C.; the butane conversion rate may achieve 80%; and ethylene and propylene had the selectivity of 34% and 20% respectively. Said patents also alleged that naphtha and fluidized-bed reactors could be used therein.

CN1317546A of ENICHEM SPA (IT) disclosed a steam cracking catalyst having the chemical formula of 12CaO.7Al₂O₃. Naphtha may be used as the raw materials. The reaction was carried out at a temperature of 720-800° C. and under 1.1-1.8 atmospheric pressure, and the contact time was 0.07-0.2 s. The yield of ethylene and propylene may achieve 43%.

USSR Pat1298240.1987 disclosed feeding Zr₂O₃ and potassium vanadate loaded on pumice or ceramic into a medium-size apparatus having a temperature of 660-780° C. and a space velocity of 2-5 hour⁻¹, wherein the weight ratio of water/straight-run gasoline may be 1:1. The normal alkane C₇₋₁₇, cyclohexane and straight-run gasoline were used as the raw materials, wherein the ethylene yield could achieve 46%, and propylene 8.8%.

CN1480255A introduced an oxide catalyst for producing ethylene-propylene by catalytically cracking naphtha as the raw materials at a temperature of 780° C., wherein the ethylene-propylene yield may achieve 47%.

In conclusion, molecular sieves as the primary cracking catalysts are attached great importance. However, the examples regarding mixing with oxides are rarely reported.

### CONTENTS OF THE INVENTION

The technical problems to be solved by the present invention are high reaction temperature, low cryogenic activity of catalysts and worse selectivity during the preparation of ethylene-propylene by catalytic cracking in the prior art, and to provide a novel catalyst for catalytic cracking fluidized-bed. Said catalyst is used to produce ethylene-propylene by catalytically cracking naphtha, which not only decreases the catalytic cracking temperature, but also enhances the selectivity of the catalyst.

In order to solve the problems above, the present invention carries out the technical solution of a catalyst for catalytic cracking fluidized-bed, comprising at least one support selected from the group consisting of SiO₂, Al₂O₃, molecular sieves and composite molecular sieves, and a composition having the chemical formula (on the basis of atom ratio):

AₐB_{b}P_{c}Oₓ,

wherein A therein is at least one selected from the group consisting of rare earth elements; B is at least one element selected from the group consisting of VIII, IB, IIB, VIIB, VIB, IA and IIA; a ranges from 0.01-0.5; b ranges from 0.01-0.5; c ranges from 0.01-0.5; and X is the total number of oxygen atoms satisfying the requirements on the valence of each of the elements in the catalyst. Said molecular sieves are optionally at least one selected from the group consisting of ZSM-5, Y zeolite, β zeolite, MCM-22, SAPO-34 and mordenite; said composite molecular sieves are the composite co-grown by at least two molecular sieves selected from the group consisting of ZSM-5, Y zeolite, β zeolite, MCM-22, SAPO-34 and mordenite. The molecular sieves in the catalyst are in an amount of 0-60% by weight of the catalyst.

In the technical solution above, a preferably ranges from 0.01-0.3; b preferably ranges from 0.01-0.3; c preferably ranges from 0.01-0.3. The preferred rare earth element is at least one selected from the group consisting of La and Ce; the preferred VIII group element is at least one selected from the group consisting of Fe, Co and Ni; the preferred IB is at least one selected from the group consisting of Cu and Ag; the preferred IIB is Zn; the preferred VIIB is Mn; the preferred VIB is selected from the group consisting of Cr, Mo and mixtures thereof; the preferred IA is at least one selected from the group consisting of Li, Na and K; and the preferred IIA is at least one selected from the group consisting of Ma, Ca, Ba and Sr. The preferred molecular sift is at least one selected from the group consisting of ZSM-5, Y zeolite, mordenit and β zeolite; and the composite molecular sift is at least one selected from the group consisting of ZSM-5/mordenit, ZSM-5/Y zeolite and ZSM-5/β zeolite. The silica alumina molar ratio SiO₂/Al₂O₃ of molecular sieves and composite molecular sieves preferably ranges from 10-500, more preferably 20-300. In the catalyst, the molecular sieves are in an amount of 10-60% by weight, preferably 20-50% by weight of the catalyst.

The catalyst for catalytic cracking fluidized-bed of the present invention is used to catalytically crack heavy oil, light diesel oil, light gasoline, catalytically cracked gasoline, gas oil, condensate oil, C4 olefin or C5 olefin.

During the preparation of the catalyst for catalytic cracking fluidized-bed of the present invention, the elements A in the raw materials are the corresponding nitrates, oxalates or oxides; the elements B are the corresponding nitrates, oxalates, acetates or soluble halides; and the phosphorus element used therein is derived from phosphoric acid, triammonium phosphate, diammonium phosphate and ammonium dihydrogen phosphate.

In the preparation of the catalyst, active elements may be impregnated onto the molecular sieves, or homogeneously mixed with molecular sieves for moulding. The preparation of the moulding form of the catalyst comprises heating and relfowing the slurry added with various ingredient elements and supports in a water bath having a temperature of 70-80° C. for 5 hours and spray-drying. The resulted powder is then calcined in the muffle furnace at a temperature of 600-750° C. for 3-10 hours.

Since at least one selected from the group of SiO₂, Al₂O₃, molecular sieves or composite molecular sieves having acidity, shape selectivity and high specific surface area is used as the cracking auxiliary agent, it is advantageous to cracking olefin materials according to the carbonium ion mechanism, producing low carbon olefins, and obtaining the synergistic effects when being compounded with active ingredients having oxidation reduction. At a relatively low temperature (580-650° C.), it achieves better catalytically cracking effects, obtains relatively high ethylene-propylene yield and better technical effects.

In order to evaluate the activity of the catalyst of the present invention, naphtha is used as the raw material (see Table 1 for specific indexes). The reaction is carried out at a temperature of 580-650° C., a catalyst loading of 0.5-2 g naphtha/g catalyst·h, and a water/naphtha weight ratio of 0.5-3:1. The fluidized-bed reactor has an inner diameter of 39 mm and a reaction pressure of 0-0.2 MPa.

TABLE 1
Indexes of naphtha raw material

| Items | Data |
|---|---|
| Density (20° C.) kg/m3 | 704.6 |
| Distillation range, initial distillation range, ° C. | 40 |
| Final distillation range, ° C. | 60 |
| Saturated steam pressure (20° C.) kpa | 50.2 |
| Alkane % (by weight) | 65.2 |
| Normal Alkane % | 32.5 |
| Cyclane % | 28.4 |
| Olefin % (by weight) | 0.17 |
| Arene % (by weight) | 6.2 |

The present invention is further elucidated via the following examples.

### MODE OF CARRYING OUT THE INVENTION

### Example 1

2 g of ammonium nitrate was dissolved into 100 ml of water, and 20 g of ZSM-5 molecular sieves row powder (having a silica alumina molar ratio SiO₂/Al₂O₃ of 400) was added therein. After the exchange for 2 hours at 90° C., the filtration was carried out to obtain the filter cake.

16.2 g of ferric nitrate, 7.86 g of cobalt nitrate, 12.23 g of chromic nitrate and 2.4 g of lanthanum nitrate were dissolved into 250 ml of water to obtain the solution A. 4.65 g of diammonium phosphate was dissolved into 100 ml of water and then added into the solution A, to obtain the slurry B after homogeneous stirring.

The slurry B was heated in a water bath having a temperature of 70-80° C., and 15 g of molecular sieves after exchange and 5 g of silicon dioxide were added therein. After refluxing for 5 hours, the slurry was dried and moulded by a spray-drying apparatus.

The dried powder was heated in the muffle furnace at a temperature of 740° C. and ignited for 5 hours, to obtain a catalyst after cooling. The catalyst was then passed through the sift having 100 meshes.

The chemical formula of the catalyst, Fe_{0.11}Co_{0.08}Cr_{0.08}La_{0.04}P_{0.05}Oₓ+Support 31.57 wt. %, was obtained.

The catalyst activity was evaluated under the following conditions: a fluidized-bed reactor having 39 mm inner diameter, a reaction temperature of 650° C. and a pressure of 0.15 MPa. The water/naphtha weight ratio was 3:1; the catalyst loading amount was 20 g; and the loading was 1 g of naphtha/g catalyst·hour. The gaseous product was collected to carry out the gas phase chromatoraphic analysis, wherein the product distribution and the ethylene+propylene yield were shown in Table 2.

TABLE 2
Gas phase product distribution and ethylene + propylene yield

| | Content (vol % for H₂, |
|---|---|
| Products | and wt % for the balance) |
| H₂ (vol %) | 15.5 |
| Methane | 17.08 |
| Ethane | 1.62 |
| Ethylene | 42.23 |
| Propane | 0.41 |
| Propylene | 14.72 |
| C₄ | 7.98 |
| the balance | 15.96 |
| Conversion rate | 76.37 |
| Ethylene yield | 32.25 |
| Propylene yield | 11.24 |
| Ethylene + propylene yield | 43.49 |

### Example 2

2 g of ammonium nitrate was dissolved into 100 ml of water, and 20 g of Y molecular sieves raw powder (having a silica alumina molar ratio SiO₂/Al₂O₃ of 20) was added therein. After the exchange for 2 hours at 90° C., the filtration was carried out to obtain the filter cake.

7.27 g of nickel nitrate, 8.48 g of chromic nitrate and 5.44 g of cerous nitrate were dissolved into 250 ml of water to obtain the solution A. 6.54 g of diammonium phosphate was dissolved into 100 ml of water and then added into the solution A, to obtain the slurry B after homogeneous stirring.

15 g of molecular sieves after exchange, 5 g of silicon dioxide and 2 g of alumina were added into the slurry B. The remaining was the same as Example 1 to obtain the chemical formula of the catalyst, Ni_{0.07}Cr_{0.06}Ce_{0.09}P_{0.08}Oₓ+Support 44.9 wt. %.

The catalyst evaluation was the same as Example 1, and the cracked product distribution and the ethylene+propylene yield were shown in Table 3.

TABLE 3
Gas phase product distribution and ethylene + propylene yield

| | Content (vol % for H₂, |
|---|---|
| Products | and wt % for the balance) |
| H₂ (vol %) | 15.52 |
| Methane | 20.46 |
| Ethane | 2.40 |
| Ethylene | 44.00 |
| Propane | 0.37 |
| Propylene | 14.28 |
| C₄ | 5.60 |
| the balance | 12.89 |
| Conversion rate | 75.26 |
| Ethylene yield | 33.11 |
| Propylene yield | 10.75 |
| Ethylene + propylene yield | 43.86 |

### Example 3

5.49 g of cobalt nitrate, 5.60 g of zinc nitrate, 5.44 g of cerous nitrate, 6.30 g of copper nitrate were dissolved into 250 ml of water to obtain the solution A. 6.54 g of diammonium phosphate was dissolved into 100 ml of water and then added into the solution A, to obtain the slurry B after homogeneous stirring.

10 g of hydrogen-type ZSM-5 molecular sieves having a silica alumina ratio of 120, 5 g of hydrogen-type β zeolite having a silica alumina ratio of 30 and 5 g of silicon dioxide were added into the slurry B. The remaining was the same as Example 1 to obtain the chemical formula of the catalyst, Co_{0.06}Zn_{0.06}Cu_{0.08}Ce_{0.09}P_{0.08}Oₓ+Support 40.5 wt. %.

The product yield was shown in Table 4.

### Example 4

7.62 g of ferric nitrate, 5.60 g of zinc nitrate, 5.44 g of cerous nitrate, 5.18 g of calcium nitrate were dissolved into 250 ml of water to obtain the solution A. 6.54 g of diammonium phosphate was dissolved into 100 ml of water and then added into the solution A, to obtain the slurry B after homogeneous stirring.

5 g of hydrogen-type mordenite having a silica alumina ratio of 20, 5 g of hydrogen-type MCM-22 having a silica alumina ratio of 40, 22.5 g of hydrogen-type β zeolite having a silica alumina ratio of 30 and 5 g of silicon dioxide were added to the solution. The remaining was the same as Example 1 to obtain the chemical formula of the catalyst, Fe_{0.05}Zn_{0.06}Ce_{0.09}Ca_{0.04}P_{0.08}Oₓ+Support 39.7 wt. %.

The product yield was shown in Table 4.

### Example 5

5.49 g of cobalt nitrate, 10.81 g of 50% manganous nitrate solution and 5.44 g of cerous nitrate were dissolved into 250 ml of water to obtain the solution A. 6.54 g of diammonium phosphate was dissolved into 100 ml of water and then added into the solution A, to obtain the slurry B after homogeneous stirring.

20 g of alumina was added to the slurry B, and the remaining was the same as Example 1 to obtain the chemical formula of the catalyst, Mn_{0.08}Co_{0.06}Ce_{0.09}P_{0.08}Oₓ+Support 46.6 wt. %.

The product yield was shown in Table 4.

### Example 6

5.49 g of cobalt nitrate, 10.81 g of 50% manganous nitrate solution and 5.44 g of cerous nitrate were dissolved into 250 ml of water to obtain the solution A. 6.54 g of diammonium phosphate was dissolved into 100 ml of water and then added into the solution A, to obtain the slurry B after homogeneous stirring.

20 g of silicon dioxide was added to the slurry B, and the remaining was the same as Example 1 to obtain the chemical formula of the catalyst, Mn_{0.08}CO_{0.06}Ce_{0.09}P_{0.08}Oₓ+Support 46.6 wt. %.

The product yield was shown in Table 4.

### Example 7

5.49 g of cobalt nitrate, 8.48 g of chromic nitrate, 5.44 g of cerous nitrate and 1.1 g of potassium nitrate were dissolved into 250 ml of water to obtain the solution A. 6.54 g of diammonium phosphate was dissolved into 100 ml of water and then added into the solution A, to obtain the slurry B after homogeneous stirring.

15 g of silica and 5 g of alumina as the support were added to the slurry B, and the remaining was the same as Example 1 to obtain the chemical formula of the catalyst, Co_{0.06}Cr_{0.06}Ce_{0.09}K_{0.02}P_{0.08}Oₓ+45.1 wt. % Support (containing no molecular sieves).

The product yield was shown in Table 4.

TABLE 4
Product yield of different supports

| | | | Ethylene + propylene |
|---|---|---|---|
| Examples | Ethylene yield | Propylene yield | yield |
| Example 3 | 36.0% | 5.47% | 41.47% |
| Example 4 | 25.37% | 15.35% | 40.72% |
| Example 5 | 30.71% | 9.33% | 40.04% |
| Example 6 | 26.98% | 12.49% | 39.47% |
| Example 7 | 27.12% | 12.33% | 39.45% |

### Example 8

The slurry B was prepared according to the process in Example 1. The same ZSM-5 molecular sieves and silicon dioxide were added directly without any loading process. After homogeneous stirring, the slurry B was directly moulded by spraying. The composition of the catalyst was the same as that in Example 1. Then the evaluation was carried out according to the process of Example 1, and the results were shown in Table 5.

### Example 9

284 g of sodium metasilicate was dissolved into 300 g of distilled water to obtain the solution A. 33.3 g of aluminium sulphate and 100 g of distilled water were prepared into the solution B. The solution B was slowly poured into the solution A and strongly stirred. Then 24.4 g of ethylene diamine was added, and the pH thereof was adjusted to 11.5 with weak sulphuric acid after stirring for a period of time. The molar proportion of the sol was controlled to be Si:Al:ethylene diamine:H₂O=1:0.1:0.4:40. The mixed solutions were fed into the autoclave, thermally insulated at 180° C. for 40 hours, taken out, washed with water, dried and calcined to obtain composite molecular sieves of ZSM-5 and mordenite. Said composite molecular sieves were exchanged twice at 70° C. with 5% ammonium nitrate solution and then calcined. Said process was repeated twice to obtain the hydrogen-type ZSM-5/mordenite composite molecular sieves.

The slurry B was prepared according to the process in Example 1. ZSM-5/mordenite composite molecular sieves having a silica alumina ratio of 20 and silicon dioxide in the same amount were added therein, and the same process was used to prepare a catalyst. Then the evaluation was carried out according to the process of Example 1, and the results were shown in Table 5.

### Example 10

284 g of sodium metasilicate was dissolved into 300 g of distilled water to obtain the solution A. 33.3 g of aluminium sulphate and 100 g of distilled water were prepared into the solution B. The solution B was slowly poured into the solution A and strongly stirred. Then 24.4 g of ethylene diamine was added, and the pH thereof was adjusted to 11 with weak sulphuric acid after stirring for a period of time. 5 g of Y zeolite crystal seeds were added therein, and the molar proportion of the sol was controlled to be Si:Al:ethylene diamine:H₂O=1:0.1:0.4:40. The mixed solutions were fed into the autoclave, thermally insulated at 170° C. for 36 hours, taken out, washed with water, dried and calcined to obtain composite molecular sieves of ZSM-5 and Y zeolite. Said composite molecular sieves were exchanged twice at 70° C. with 5% ammonium nitrate solution and then calcined. Said process was repeated twice to obtain the hydrogen-type ZSM-5/Y zeolite composite molecular sieves.

The slurry B was prepared according to the process in Example 1. ZSM-5/Y zeolite composite molecular sieves having a silica alumina ratio of 20 and silicon dioxide in the same amount were added therein, and the same process was used to prepare a catalyst. Then the evaluation was carried out according to the process of Example 1, and the results were shown in Table 5.

### Example 11

284 g of sodium metasilicate was dissolved into 300 g of distilled water to obtain the solution A. 33.3 g of aluminium sulphate and 100 g of distilled water were prepared into the solution B. The solution B was slowly poured into the solution A and strongly stirred. Then 24.4 g of ethylene diamine and 10 g of tetraethyl ammonium hydroxide were added, and the pH thereof was adjusted to 12 with weak sulphuric acid after stirring for a period of time. 5 g of β zeolite crystal seeds were added, and the molar proportion of the sol was controlled to be Si:Al:ethylene diamine:H₂O=1:0.1:0.4:40. The mixed solutions were fed into the autoclave, thermally insulated at 160° C. for 40 hours, taken out, washed with water, dried and calcined to obtain composite molecular sieves of mordenite and β zeolite. Said composite molecular sieves were exchanged twice at 70° C. with 5% ammonium nitrate solution and then calcined. Said process was repeated twice to obtain the hydrogen-type mordenite/β zeolite composite molecular sieves.

The slurry B was prepared according to the process in Example 1. β zeolite/mordenite composite molecular sieves having a silica alumina ratio of 20 and silicon dioxide in the same amount were added therein, and the same process was used to prepare a catalyst. Then the evaluation was carried out according to the process of Example 1, and the results were shown in Table 5.

### Example 12

The slurry B was prepared according to the process in Example 1. 5 g of the hydrogen type ZSM-5 having a silica alumina ratio of 120, 10 g of ZSM-5/mordenite composite molecular sieves having a silica alumina ratio of 20, 5 g of silicon dioxide were added therein, and the same process was used to prepare a catalyst. Then the evaluation was carried out according to the process of Example 1, and the results were shown in Table 5.

### Example 13

The slurry B was prepared according to the process in Example 1. 12 g of the hydrogen type ZSM-5 having a silica alumina ratio of 150 as a support was added therein to obtain a catalyst having the composition chemical formula of Fe_{0.11}Co_{0.08}Cr_{0.08}La_{0.04}P_{0.05}Oₓ+Support 21.32 wt. %. Then the evaluation was carried out according to the process of Example 1, and the results were shown in Table 5.

### Example 14

The slurry B was prepared according to the process in Example 1. 20 g of the hydrogen type ZSM-5/mordenite having a silica alumina ratio of 30 as a support was added therein to obtain a catalyst having the composition chemical formula of Fe_{0.11}Co_{0.08}Cr_{0.08}La_{0.04}P_{0.05}Oₓ+Support 31.6 wt. %. Then the evaluation was carried out according to the process of Example 1, and the results were shown in Table 5.

TABLE 5

| | | | Ethylene + propylene |
|---|---|---|---|
| Examples | Ethylene yield | Propylene yield | yield |
| Example 8 | 32.36% | 11.17% | 43.53% |
| Example 9 | 33.76% | 11.45% | 45.21% |
| Example 10 | 33.42% | 10.83% | 44.25% |
| Example 11 | 32.72% | 10.87% | 43.59% |
| Example 12 | 33.47% | 11.21% | 44.68% |
| Example 13 | 34.52% | 12.07% | 46.59% |
| Example 14 | 35.02% | 12.53% | 47.55% |

### Example 15

Under the same conditions as those in Example 1, the evaluation was carried out by using the catalyst prepared according to Example 1 and the light diesel oil having a boiling point of lower than 350° C. as the reaction materials, and the results were shown in Table 6.

### Example 16

Under the same conditions of 550° C., a water/oil ratio of 3:1 and a space velocity of 1 as those in Example 1, the evaluation was carried out by using the catalyst prepared according to Example 1 and the mixed C4 (alkane:olefin=1:l) as the reaction materials, and the results were shown in Table 6.

TABLE 6

| | | | Ethylene + propylene |
|---|---|---|---|
| Examples | Ethylene yield | Propylene yield | yield |
| Example 15 | 28.47% | 9.25% | 37.72% |
| Example 16 | 12.21% | 38.63% | 50.84% |

1. A catalyst for catalytic cracking fluidized-bed, comprising at least one support selected from the group consisting of SiO₂, Al₂O₃ and composite molecular sieves, and a composition having the following chemical formula, which is on the basis of atom ratio:
AₐB_{b}P_{c}Oₓ,
wherein A therein is at least one selected from the group consisting of rare earth elements;
B is at least one element selected from the group consisting of VIII, IB, IIB, VIIB, VIB, IA and IIA;
a ranges from 0.01-0.5;
b ranges from 0.01-0.5;
c ranges from 0.01-0.5; and
x is the total number of oxygen atoms satisfying the requirements on the valence of each of the elements in the catalyst;
said composite molecular sieves are a composite co-grown by at least two molecular sieves selected from the group consisting of ZSM-5, Y zeolite, β zeolite, MCM-22, SAPO-34 and mordenite, wherein the molecular sieves in the catalyst are in an amount of 0-60% by weight of the catalyst.

2. The catalyst for catalytic cracking fluidized-bed according to claim 1, characterized in that a ranges from 0.01-0.3; b ranges from 0.01-0.3; and c ranges from 0.01-0.3.

3. The catalyst for catalytic cracking fluidized-bed according to claim 1, characterized in that the rare earth element is at least one selected from the group consisting of La and Ce.

4. The catalyst for catalytic cracking fluidized-bed according to claim 1, characterized in that the VIII group element is at least one selected from the group consisting of Fe, Co and Ni; the IB element is at least one selected from the group consisting of Cu and Ag; the IIB element is Zn; the VIIB element is Mn; the VIB element is at least one selected from the group consisting of Cr and Mo; the IA element is at least one selected from the group consisting of Li, Na and K; and the IIA element is at least one selected from the group consisting of Mg, Ca, Ba and Sr.

5. The catalyst for catalytic cracking fluidized-bed according to claim 1, characterized in that the composite molecular sieve is at least one selected from the group consisting of ZSM-5/mordenit, ZSM-5/Y zeolite and ZSM-5/β zeolite.

6. The catalyst for catalytic cracking fluidized-bed according to claim 1, characterized in that the silica alumina molar ratio SiO₂/Al₂O₃ of the composite molecular sieves ranges from 10 to 500.

7. The catalyst for catalytic cracking fluidized-bed according to claim 6, characterized in that the silica alumina molar ratio SiO₂/Al₂O₃ of the composite molecular sieves ranges from 20 to 300.

8. The catalyst for catalytic cracking fluidized-bed according to claim 1, characterized in that the molecular sieves are in an amount of 10-60% by weight of the catalyst.

9. The catalyst for catalytic cracking fluidized-bed according to claim 1, characterized in that the molecular sieves are in an amount of 20-50% by weight of the catalyst.

10. (canceled)

11. A method of catalytically cracking heavy oil, light diesel oil, light gasoline, catalytically cracked gasoline, gas oil, condensate oil, C4 olefin or C5 olefin comprising using a catalyst for catalytic cracking fluidized-bed according to claim 1.
